(19) United States
(12) Patent Application Publication
(10) Pub. No.: US 2011/0063865 A1
(43) Pub. Date: Mar. 17, 2011

(54) LIGHT EMITTING MODULE AND VEHICLE LAMP

(75) Inventors: Motohiro KOMATSU, Shizuoka-shi (JP); Hidetada TANAKA, Shizuoka-shi (JP); Takayuki YAGI, Shizuoka-shi (JP)

(73) Assignee: KOITO MANUFACTURING CO., LTD., Tokyo (JP)

(21) Appl. No.: 12/880,235

(22) Filed: Sep. 13, 2010

(30) Foreign Application Priority Data
Sep. 16, 2009 (JP) 2009-214575

(51) Int. Cl. F21V 11/00; F21V 21/00

(52) U.S. Cl. 362/509; 362/382

(57) ABSTRACT

A light emitting module includes: a circuit board having a shape in which an outer peripheral edge of the circuit board corresponds to an outer peripheral edge of the circuit board before rotating the circuit board about a center point by an angle of 90 degrees in a direction orthogonal to a thickness direction of the circuit board; a semiconductor light emitting element; and a first and second electrodes that are formed on the circuit board at positions symmetrical to each other with respect to the center point.

### CROSS REFERENCE TO RELATED APPLICATION(S)

The present disclosure relates to the subject matters contained in Japanese Patent Application No. 2009-214575 filed on Sep. 16, 2009, which are incorporated herein by reference in its entirety.

### BACKGROUND

1. Field

The present invention relates to a light emitting module and a vehicle lamp having a circuit board formed in a predetermined shape to be mounted on a mounting base so as to facilitate sharing of components disposed around a light emitting module.

2. Description of the Related Art

There is a light emitting module that uses a semiconductor light emitting element such as a light emitting diode (LED) as a light source. This light emitting module is provided in, for example, a vehicle lamp for illuminating light, which is emitted from a light source, as illumination light.

The light emitting module provided in the vehicle lamp includes a circuit board mounted on a mounting base, a pair of electrodes formed on the circuit board, and a semiconductor light emitting element electrically connected to the pair of electrodes. For example, the light emitting module is mounted on a power feed attachment and mounted on the mounting base.

The power feed attachment includes a pair of connecting terminals, which is connected to a pair of electrodes of the light emitting module, respectively, and a pair of connector terminals to which the pair of connecting terminals is connected, respectively.

A plug connected to an external power source is connected to the connector terminals of the power feed attachment. Accordingly, drive current is supplied to the semiconductor light emitting element from the external power source through the plug, the connector terminal, the connecting terminal, and the electrode in this order. As a result, the semiconductor light emitting element emits light.

In a light emitting module in the related art, a circuit board is formed in a rectangular shape, a pair of electrodes is formed on both sides of the circuit board in a longitudinal direction of the circuit board, and a rectangular semiconductor light emitting element is mounted with a predetermined orientation at a central portion of the circuit board. An example of such configuration is disclosed in JP-A-2008-016362 (counterpart U.S. publication is: US 2008/0008427 A1).

Meanwhile, there is a vehicle lamp, for example, a vehicle headlight, that includes a so-called low beam lamp unit for illuminating a close range and a so-called high beam lamp unit for illuminating a distant range. In this vehicle lamp, light distribution patterns required for the respective lamp units are different from each other. For example, a light distribution pattern, which is wide in a lateral direction, is required for the low beam lamp unit, and a light distribution pattern, which is wide in a vertical direction, is required for the high beam lamp unit.

In the light emitting module disclosed in JP-A-2008-016362, the circuit board is formed in a rectangular shape. Accordingly, the orientation of the circuit board mounted on the mounting base is determined to be one predetermined direction, and the orientation of the semiconductor light emitting element mounted on the circuit board is also determined to be a lateral direction or a longitudinal direction. For this reason, the light emitting module can only be used for only one lamp unit of the low beam lamp unit and the high beam lamp unit.

Accordingly, the mounting base on which the light emitting module is mounted or the power feed attachment on which the light emitting module is mounted is required for every kind of light emitting module. For this reason, it may not be possible to facilitate the sharing of members, such as the mounting base and the power feed attachment, which are disposed around the light emitting module.

### SUMMARY

One of objects of the present invention is to provide a light emitting module and a vehicle lamp having improved design to facilitate sharing of components disposed around the light emitting module.

According to a first aspect of the invention, there is provided a light emitting module including: a circuit board configured to be mounted on a mounting base, the circuit board having a shape in which an outer peripheral edge of the circuit board corresponds to an outer peripheral edge of the circuit board before rotating the circuit board about a center point by an angle of 90 degrees in a direction orthogonal to a thickness direction of the circuit board; a semiconductor light emitting element that is mounted on the circuit board, the semiconductor light emitting element being formed in a shape extending in a predetermined direction; and a first and second electrodes that are formed on the circuit board at positions symmetrical to each other with respect to the center point, the first and second electrodes being electrically connected to the semiconductor light emitting element and serving as positive and negative electrodes, wherein each of the first and second electrodes has a connecting portion, to which connecting terminal for supplying drive current to the semiconductor light emitting element is connected, and wherein each of the first and second electrode further has an alternative connecting portion, to which the connecting terminal is connected when the circuit board is rotated about the center point by an angle of 90 degrees in a direction orthogonal to the thickness direction of the circuit board.

According to a second aspect of the invention, there is provided a vehicle lamp including: a lamp housing having an inner space defined as a lamp chamber; a mounting base provided in the lamp chamber; a light emitting module mounted on the mounting base; and an optical member having a predetermined function for light emitted from a light emitting module, wherein the light emitting module includes: a circuit board configured to be mounted on a mounting base, the circuit board having a shape in which an outer peripheral edge of the circuit board corresponds to an outer peripheral edge of the circuit board before rotating the circuit board about a center point by an angle of 90 degrees in a direction orthogonal to a thickness direction of the circuit board; a semiconductor light emitting element that is mounted on the circuit board, the semiconductor light emitting element being formed in a shape extending in a predetermined direction; and a first and second electrodes that are formed on the circuit board at positions symmetrical to each other with respect to the center point, the first and second electrodes being electrically connected to the semiconductor light emitting element and serving as positive and negative electrodes, wherein each of the first and second electrodes has a connecting portion, to which connecting terminal for supplying drive current to the semiconductor light emitting element is connected, and wherein each of the first and second electrode further has an alternative connecting portion, to which the connecting terminal is connected when the circuit board is rotated about the center point by an angle of 90 degrees in a direction orthogonal to the thickness direction of the circuit board.

### BRIEF DESCRIPTION OF THE DRAWINGS

A general configuration that implements the various feature of the invention will be described with reference to the drawings. The drawings and the associated descriptions are provided to illustrate embodiments of the invention and not to limit the scope of the invention.

FIG. 1 is a schematic cross-sectional view of a vehicle lamp according to an embodiment of the invention.

FIG. 2 is an exploded perspective view showing alight emitting module, a power feed attachment, and a source holding member.

FIG. 3 is an enlarged plan view showing the light emitting module before and after the light emitting module is rotated by an angle of 90 degrees.

FIG. 4 is an enlarged plan view showing that the light emitting module is mounted on a mounting base so that the semiconductor light emitting element is parallel to a lateral direction.

FIG. 5 is an enlarged plan view showing that the light emitting module is mounted on the mounting base so that the semiconductor light emitting element is parallel to a longitudinal direction.

FIG. 6 is an enlarged plan view of a light emitting module of which a circuit board is formed in the shape of a regular octagon.

FIG. 7 is an enlarged plan view of a light emitting module of which a circuit board is formed in an octagonal shape.

FIG. 8 is an enlarged plan view of a light emitting module on which a pair of first electrodes and a pair of second electrodes are formed.

FIG. 9 is an enlarged plan view of a light emitting module of which a semiconductor light emitting element is formed in another shape except for a rectangular shape.

FIG. 10 is an enlarged plan view of a light emitting module of which a semiconductor light emitting element is formed in another shape different from the shape shown in FIG. 9 other than a rectangular shape.

### DETAILED DESCRIPTION OF THE EMBODIMENT(S)

An embodiment according to the present invention will be described in detail with reference to the accompanying drawings. The scope of the claimed invention should not be limited to the examples illustrated in the drawings and those described below.

A light emitting module and a vehicle lamp according to the invention will be described below with reference to accompanying drawings.

In the embodiment, a vehicle lamp according to the invention is applied to a vehicle headlight and a light emitting module according to the invention is applied to a light emitting module of the vehicle headlight. Meanwhile, the ranges of application of the vehicle lamp and the light emitting module according to the invention are not limited to a vehicle headlight and a light emitting module of a vehicle headlight. The invention may be widely applied to various vehicle lamps except for vehicle headlights that are mounted on a vehicle body, and light emitting modules that are provided in these various vehicle lamps.

Vehicle lamps (vehicle headlights) 1 are disposed and mounted on both left and right end portions of a front end portion of a vehicle body, respectively.

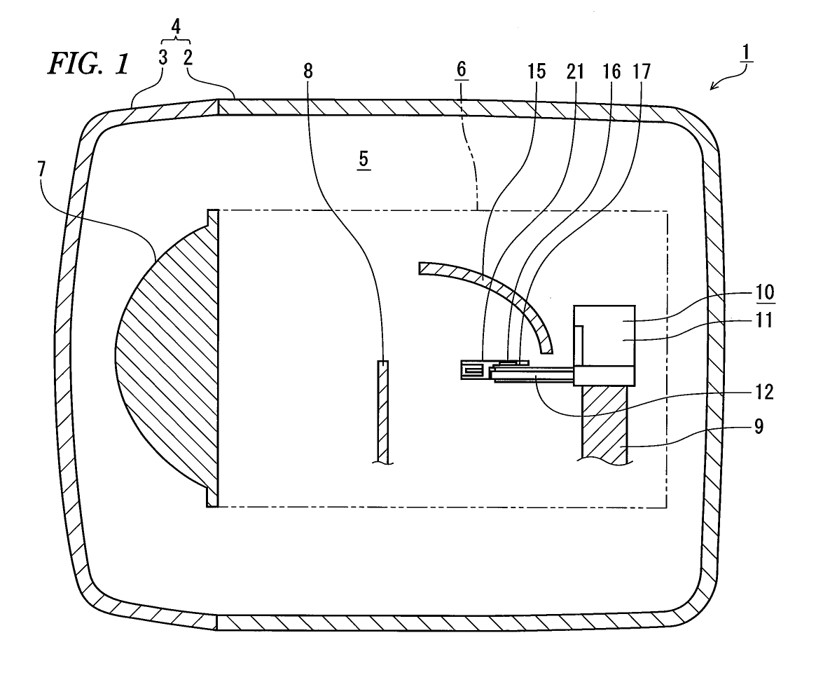

As shown in FIG. 1, the vehicle lamp 1 includes a lamp body 2 and a cover 3. The lamp body 2 includes a recess that is opened toward the front side, and the cover 3 closes the opened surface of the lamp body 2. The lamp body 2 and the cover 3 form a lamp housing 4. An inner space of the lamp housing 4 is formed as a lamp chamber 5.

A lamp unit 6 is disposed in the lamp chamber 5. The lamp unit 6 is supported in the lamp body 2 by an optical axis adjustment mechanism (not shown) to be tiltable.

The lamp unit 6 includes a lens 7, a shade 8, amounting member 9, and a light source holding member 10.

The lens 7 is formed, for example, in a substantially hemispherical shape. The lens 7 functions as an optical member having a function of projecting light, which is emitted from a semiconductor light emitting element (light source) to be described below, to the front side.

The shade 8 is disposed on the rear side of the lens 7, and functions as an optical member having a function of blocking a part of light that is emitted from the semiconductor light emitting element.

The mounting member 9 is disposed on the rear side of the shade 8. The light source holding member 10 is mounted on the mounting member 9.

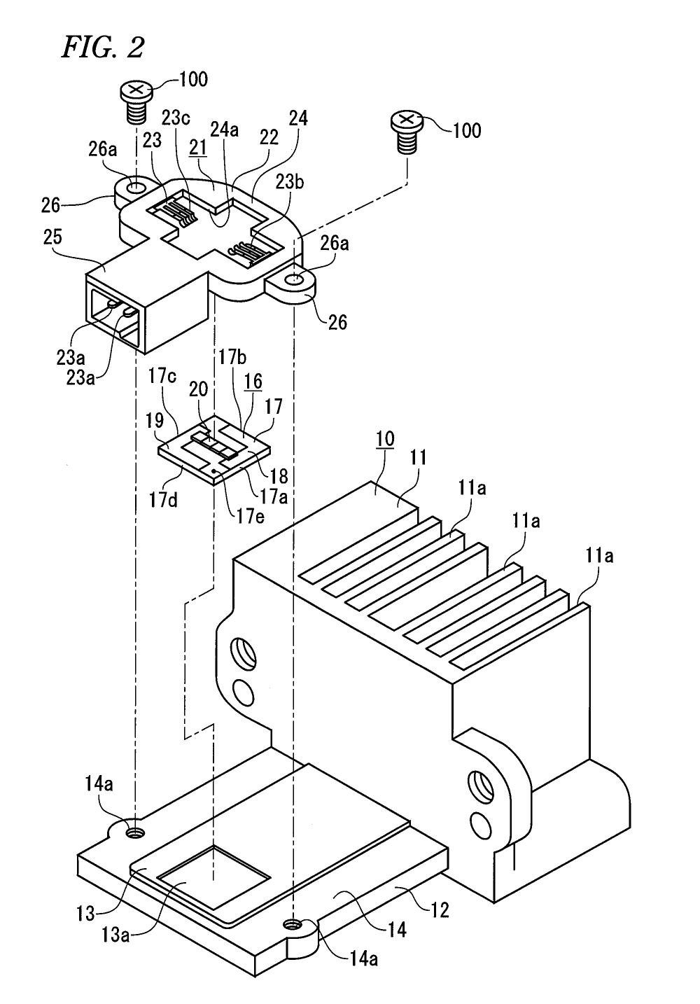

The light source holding member 10 functions as a heat radiating member that radiates heat generated in a light emitting module to be described below. The light source holding member 10 includes a heat radiating part 11 and a substantially plate-shaped mounting base 12 that protrudes forward from the heat radiating part 11 (see FIG. 2).

A plurality of heat radiating fins 11a, 11a, . . . is provided at the heat radiating part 11.

A portion of the mounting base 12 other than both the left and right side portions and a front end portion is formed as a board disposition portion 13 that protrudes in the shape of a step, and both the left and right side portions are formed as mounting surfaces 14 and 14.

A positioning recess 13a, which is opened upward, is formed in a square shape on the board disposition portion 13.

Screw holes 14a and 14a, which are opened upward, are formed at the mounting surfaces 14 and 14, respectively.

A reflector 15 is disposed above the mounting base 12 (see FIG. 1). The reflector 15 functions as an optical member having a function of reflecting the light, which is emitted from the semiconductor light emitting element, and guiding the light to the lens 7.

A light emitting module 16 is mounted on the mounting base 12 (see FIG. 2). The light emitting module 16 includes a circuit board 17 that is placed on the mounting base 12, a first electrode 18 that is formed on the upper surface of the circuit board 17, a second electrode 19 that is formed on the upper surface of the circuit board 17, and a semiconductor light emitting element 20 that is mounted on the upper surface of the circuit board 17.

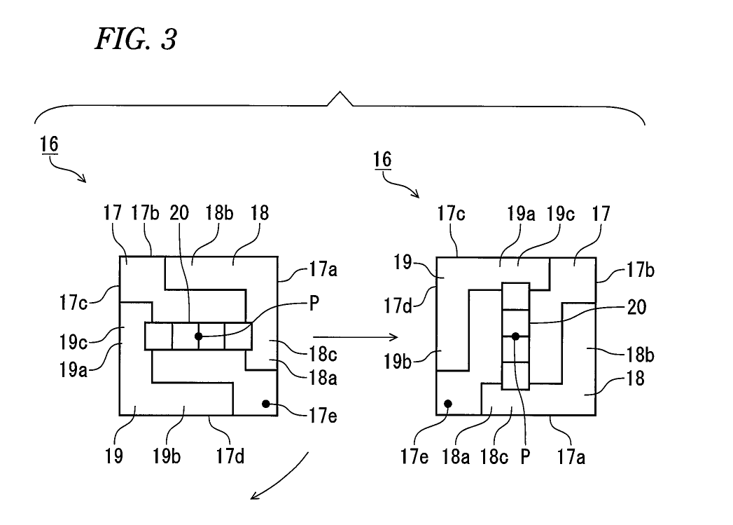

The circuit board 17 is formed, for example, in a square shape, and outer peripheral edges of the circuit board are formed of four side edges 17a, 17b, 17c, and 17d that are sequentially continuous. Accordingly, for example, if the circuit board is rotated about a center point P by an angle of 90 degrees in a direction orthogonal to the thickness direction of the circuit board when the side edges 17a and 17c are positioned on the left and right sides (the left-hand drawing of FIG. 3), the shapes of the side edges 17b and 17d after the rotation of the circuit board (the right-hand drawing of FIG. 3) correspond to the shapes of the side edges 17a and 17c before the rotation of the circuit board.

For example, the center point P corresponds to the center of gravity of the circuit board 17.

A indicator 17e is formed at a portion, where the first and second electrodes 18 and 19 are not formed, on the upper surface of the circuit board 17 (see FIG. 2). The indicator 17e functions as a mark that is used to determine the orientation when the light emitting module 16 is mounted on the mounting base 12. For example, the indicator 17e may be printed on the upper surface of the circuit board 17, and may be small holes, recesses, notches, or the like formed on the circuit board 17.

The first electrode 18 is positioned at an outer peripheral portion of the circuit board 17, is formed in a “V” shape along two continuous side edges 17a and 17b, and includes a first portion 18a formed along the side edge 17a and a second portion 18b formed along the side edge 17b. A part of the first portion 18a is formed as a connecting portion 18c to which connecting terminals of a power feed attachment to be described below are connected.

The second electrode 19 is positioned at an outer peripheral portion of the circuit board 17, is formed in a “V” shape along two continuous side edges 17c and 17d, and includes a first portion 19a formed along the side edge 17c and a second portion 19b formed along the side edge 17d. A part of the first portion 19a is formed as a connecting portion 19c to which connecting terminals of a power feed attachment are connected.

The first electrode 18 is formed as, for example, a positive electrode. The second electrode 19 is formed as, for example, a negative electrode. The first and second electrodes 18 and 19 are formed at positions on the circuit board 17 that are symmetrical to each other with respect to the center point P. Accordingly, if the circuit board 17 is rotated about the center point P by an angle of 90 degrees when the first portion 18a of the first electrode 18 and the first portion 19a of the second electrode 19 are positioned on the left and right sides (the left-hand drawing of FIG. 3), the second portion 18b of the first electrode 18 and the second portion 19b of the second electrode 19 are positioned on the left and right sides after the rotation of the circuit board (the right-hand drawing of FIG. 3).

A semiconductor light emitting element 20 is formed of a plurality of light emitting diodes (LED), and is formed in a rectangular shape that extends in a horizontal direction (see FIG. 2). Accordingly, both end portions of the semiconductor light emitting element 20 in the longitudinal direction are connected to the first portion 18a of the first electrode 18 and the first portion 19a of the second electrode 19, respectively.

The light emitting module 16 is mounted on a power feed attachment 21, and is mounted on the mounting base 12 of the light source holding member 10.

The power feed attachment 21 includes a resin molded portion 22 that is made of a resin material and a conductive portion 23 that is made of a metal material.

The resin molded portion 22 includes a frame-like portion 24, a connector case 25 that protrudes forward from the frame-like portion 24, and mounted pieces 26 and 26 that protrude from the frame-like portion 24 to the left and right sides, respectively.

An opening, which is formed inside the frame-like portion 24, is formed as a disposition opening 24a.

The connector case 25 is formed in the shape of a substantially rectangular tube that is opened toward the front side.

Screw insertion holes 26a and 26a, which pass through the mounted pieces in a vertical direction, are formed at the mounted pieces 26 and 26, respectively.

The conductive portion 23 is partially embedded in the resin molded portion 22. The conductive portion 23 includes connector terminals 23a and 23a that are not embedded in the resin molded portion 22, and connecting terminals 23b and 23c.

The connector terminals 23a and 23a protrude forward from the resin molded portion 22 and are positioned on the left and right sides in the connector case 25 so as to be spaced apart from each other.

Portions of the respective connecting terminals 23b and 23c, which exclude the outer ends thereof, are formed, for example, in a three-forked shape, have a spring property, and protrude from the left and right edges of the disposition opening 24a so as to approach each other.

The circuit board 17 of the light emitting module 16 having the above-mentioned structure is disposed and positioned at the positioning recess 13a of the board disposition portion 13 of the mounting base 12 of the light source holding member 10. In this case, the indicator 17e formed on the circuit board 17 functions as a mark, so that the circuit board 17 is disposed on the mounting base 12 in an appropriate orientation.

Since the indicator 17e is formed at the light emitting module 16 as described above, it may be possible to reliably dispose the light emitting module 16 on the mounting base 12 in an appropriate orientation.

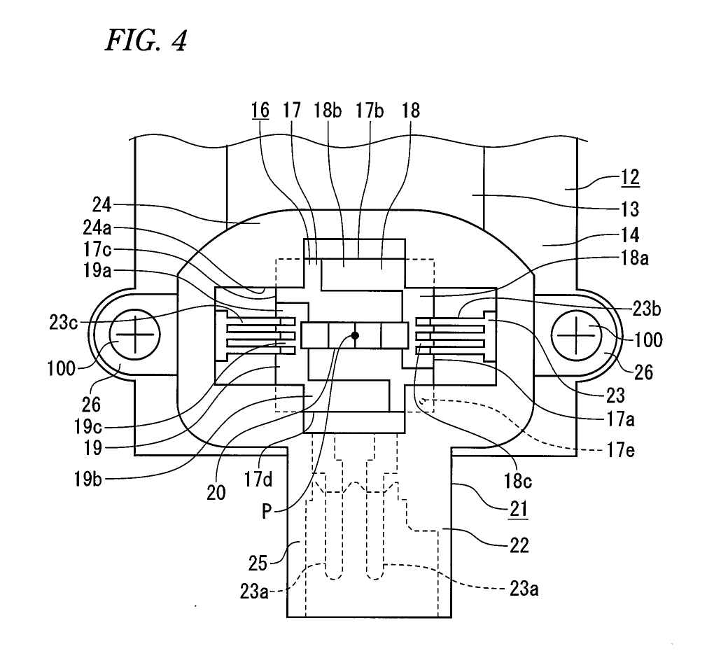

The power feed attachment 21 is disposed on the mounting base 12 so as to cover the circuit board 17 from above (see FIG. 4). When the power feed attachment 21 is disposed on the mounting base 12, the connecting terminals 23b and 23c of the conductive portion 23 are pressed against the connecting portion 18c of the first portion 18a of the first electrode 18 and the connecting portion 19c of the first portion 19a of the second electrode 19 from above. Accordingly, the connecting terminals of the conductive portion are connected to the connecting portions of the first portions of the first and second electrodes, respectively. In this case, the circuit board 17 is mounted on the mounting base 12, so that a part of the circuit board 17 is pressed from above by a part of the resin molded portion 22.

Mounting screws 100 and 100 pass through the screw insertion holes 26a and 26a of the mounted pieces 26 and 26 and are fastened to the screw holes 14a and 14a, so that the power feed attachment 21 is fixed to the mounting base 12.

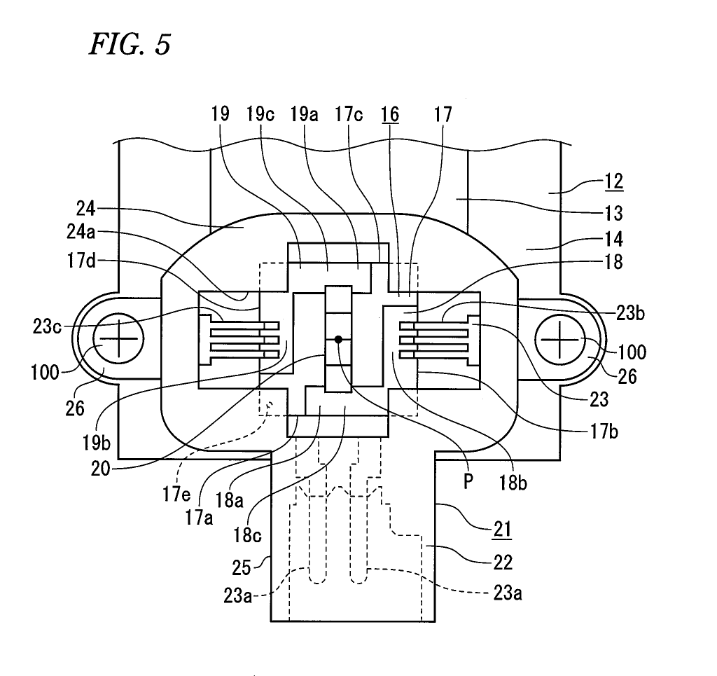

Further, the light emitting module 16 may be mounted on the mounting base 12 in the vehicle lamp 1 so that the semiconductor light emitting element 20 is parallel to a longitudinal direction (see FIG. 5). In order to mount the light emitting module 16 on the mounting base 12 so that the semiconductor light emitting element 20 is parallel to the longitudinal direction, the light emitting module 16 is mounted on the mounting base 12 so as to be rotated by an angle of 90 degrees in a direction orthogonal to the thickness direction.

When the light emitting module 16 is rotated by an angle of 90 degrees, the second portion 18b of the first electrode 18 and the second portion 19b of the second electrode 19 are positioned on the left and right sides after the rotation of the light emitting module as described above. Further, in this case, the second portion 18b of the first electrode 18 and the second portion 19b of the second electrode 19 exist at the positions where the connecting portion 18c of the first portion 18a of the first electrode 18 and the connecting portion 19c of the first portion 19a of the second electrode 19 did not exist before the rotation of the light emitting module.

The connecting terminals 23b and 23c are pressed against the second portion 18b of the first electrode 18 and the second portion 19b of the second electrode 19 from above, respectively, so that the power feed attachment 21 is connected.

In the embodiment, the second portion 18b of the first electrode 18 and the second portion 19b of the second electrode 19 are configured to serve as alternative connecting portions, to which the connecting terminals 23b and 23c are connected when the circuit board 17 is rotated about the center point P by an angle of 90 degrees in a direction orthogonal to the thickness direction of the circuit board.

As described above, in the vehicle lamp 1, when the circuit board 17 of the light emitting module 16 is rotated by an angle of 90 degrees in the direction orthogonal to the thickness direction, the shape of the outer peripheral edge of the circuit board corresponding to an arbitrary position after the rotation of the circuit board corresponds to the shape of the outer peripheral edge of the circuit board corresponding to the arbitrary position before the rotation of the circuit board. Further, the second portion 18b of the first electrode 18 and the second portion 19b of the second electrode 19 after the rotation of the circuit board exist at the positions of the connecting portion 18c of the first electrode 18 and the connecting portion 19c of the second electrode 19 before the rotation of the circuit board.

Accordingly, when the orientation of the semiconductor light emitting element 20 is changed by rotating the circuit board 17 by an angle of 90 degrees in the direction orthogonal to the thickness direction of the circuit board, it may be possible to mount the light emitting module 16 on the mounting base 12 without changing the shape and size of the mounting base 12 and the power feed attachment 21. Moreover, it may be possible to facilitate the sharing of members that are related to the power feed attachment 21 and the mounting base 12 disposed around the light emitting module 16.

Further, since the circuit board 17 has been formed in a square shape, it may be possible to easily form the light emitting module 16 and to facilitate the sharing of members, which are related to the power feed attachment 21 and the mounting base 12, by using a simple shape.

Furthermore, the first electrode 18 is formed of the first and second portions 18a and 18b that are formed along the two continuous side edges 17a and 17b of the circuit board 17, respectively. Moreover, the second electrode 19 is formed of the first and second portions 19a and 19b that are formed along the two continuous side edges 17c and 17d of the circuit board 17. Accordingly, portions, which are to be connected to the connecting terminals 23b and 23c of the power feed attachment 21 when the light emitting module 16 is rotated by an angle of 90 degrees, are secured by a simple structure. As a result, it may be possible to facilitate the sharing of members, which are related to the power feed attachment 21 and the mounting base 12, by a simple structure.

Meanwhile, an example where the circuit board of the light emitting module is formed in a square shape has been described above, but the shape of the circuit board is not limited to the square shape. As long as the shape of the outer peripheral edge of the circuit board corresponding to an arbitrary position after the rotation of the circuit board corresponds to the shape of the outer peripheral edge of the circuit board corresponding to the arbitrary position before the rotation of the circuit board when the circuit board is rotated about the center point by an angle of 90 degrees in the direction orthogonal to the thickness direction, the circuit board may be formed in any shape.

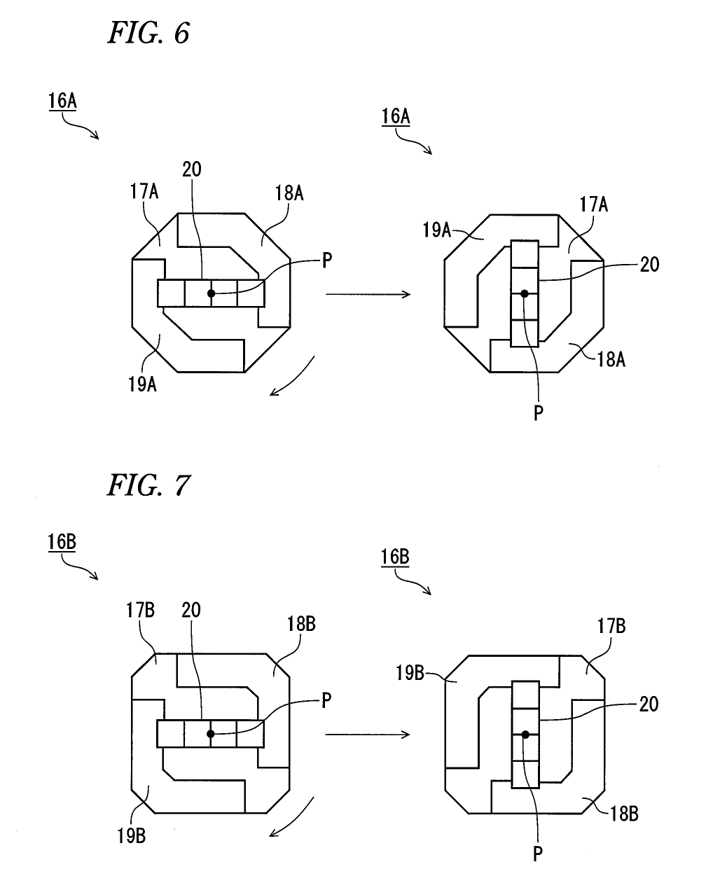

For example, as an example of this light emitting module, there are light emitting modules 16A and 16B as shown in FIGS. 6 and 7. The light emitting modules 16A and 16B include circuit boards 17A and 17B, which are formed in the shape of octagons including a regular octagon, respectively. First electrodes 18A and 18B and second electrodes 19A and 19B are formed on the circuit boards 17A and 17B, respectively.

Further, an example where each of the first and second electrodes is formed in a “V” shape has been described above, but the shape of each of the first and second electrodes is not limited to the “V” shape. As long as a part of the first electrode and a part of the second electrode after the rotation of the circuit board exist at the positions where the connecting portion of the first electrode and the connecting portion of the second electrode did exist before the rotation of the circuit board, each of the first and second electrodes may be formed at any position and in any shape.

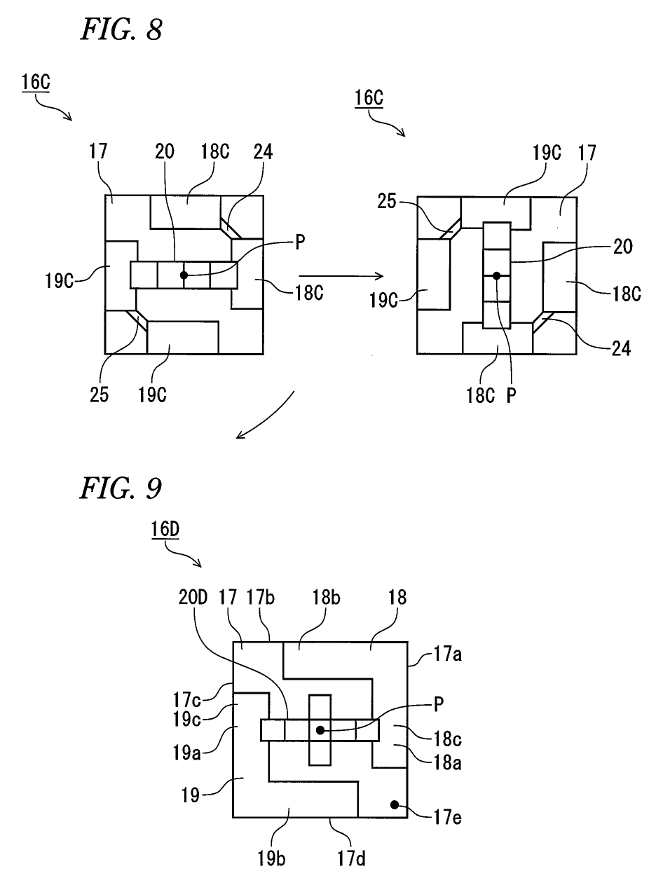

For example, a light emitting module 16C is shown in FIG. 8 as this example. In the light emitting module 16C, a pair of first electrodes 18C and 18C formed along side edges 17a and 17b is formed on a circuit board 17 and the first electrodes 18C and 18C are connected to each other by a connecting pattern 24. A pair of second electrodes 19C and 19C formed along side edges 17c and 17d is formed on the circuit board and the second electrodes 19C and 19C are connected to each other by a connecting pattern 25.

In addition, an example where the semiconductor light emitting element is formed in a rectangular shape has been described above, but the shape of the semiconductor light emitting element is not limited to the rectangular shape. As long as the shape of the semiconductor light emitting element extends in a predetermined direction, the semiconductor light emitting element may be formed in any shape.

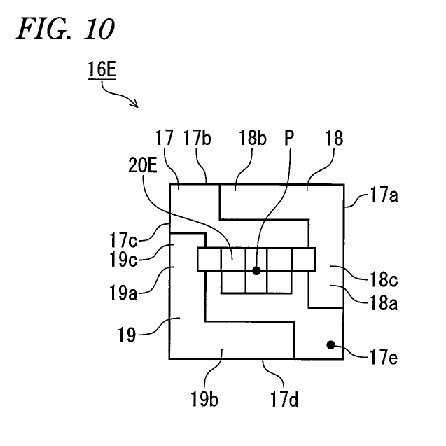

For example, there are light emitting modules 16D and 16E shown in FIGS. 9 and 10 as an example of the semiconductor light emitting element having the above-mentioned shape. The light emitting module 16D includes a semiconductor light emitting element 20D of which a part protrudes in a direction orthogonal to a longitudinal direction (see FIG. 9), and the light emitting module 16E includes a semiconductor light emitting element 20E to which a light emitting diode is adjacent in a direction orthogonal to a longitudinal direction (see FIG. 10).

The shapes and structures of the respective components described in the above-mentioned embodiment are merely examples for the embodiment of the invention, and the scope of the invention should not be limitedly interpreted.

Although the embodiment according to the present invention has been described above, the present invention is not limited to the above-mentioned embodiment but can be variously modified. Constituent components disclosed in the aforementioned embodiment may be combined suitably to form various modifications. For example, some of all constituent components disclosed in the embodiment may be removed or may be appropriately combined.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A light emitting module comprising:
a circuit board configured to be mounted on a mounting base, the circuit board having a shape in which an outer peripheral edge of the circuit board corresponds to an outer peripheral edge of the circuit board before rotating the circuit board about a center point by an angle of 90 degrees in a direction orthogonal to a thickness direction of the circuit board;
a semiconductor light emitting element that is mounted on the circuit board, the semiconductor light emitting element being formed in a shape extending in a predetermined direction; and
a first and second electrodes that are formed on the circuit board at positions symmetrical to each other with respect to the center point, the first and second electrodes being electrically connected to the semiconductor light emitting element and serving as positive and negative electrodes,
wherein each of the first and second electrodes has a connecting portion, to which connecting terminal for supplying drive current to the semiconductor light emitting element is connected, and
wherein each of the first and second electrode further has an alternative connecting portion, to which the connecting terminal is connected when the circuit board is rotated about the center point by an angle of 90 degrees in a direction orthogonal to the thickness direction of the circuit board.

2. The light emitting module according to claim 1,
wherein the circuit board is formed in a square shape.

3. The light emitting module according to claim 2,
wherein each of the first and second electrodes is formed to have first and second portions that are continuously formed along two continuous side edges of the outer peripheral edges of the circuit board, respectively.

4. The light emitting module according to claim 1,
wherein the circuit board has an indicator that indicates orientation of the circuit board to be mounted on the mounting base.

5. A vehicle lamp comprising:
a lamp housing having an inner space defined as a lamp chamber;
a mounting base provided in the lamp chamber;
a light emitting module mounted on the mounting base; and
an optical member having a predetermined function for light emitted from a light emitting module,
wherein the light emitting module comprises:
a circuit board configured to be mounted on a mounting base, the circuit board having a shape in which an outer peripheral edge of the circuit board corresponds to an outer peripheral edge of the circuit board before rotating the circuit board about a center point by an angle of 90 degrees in a direction orthogonal to a thickness direction of the circuit board;
a semiconductor light emitting element that is mounted on the circuit board, the semiconductor light emitting element being formed in a shape extending in a predetermined direction; and
a first and second electrodes that are formed on the circuit board at positions symmetrical to each other with respect to the center point, the first and second electrodes being electrically connected to the semiconductor light emitting element and serving as positive and negative electrodes,
wherein each of the first and second electrodes has a connecting portion, to which connecting terminal for supplying drive current to the semiconductor light emitting element is connected, and
wherein each of the first and second electrode further has an alternative connecting portion, to which the connecting terminal is connected when the circuit board is rotated about the center point by an angle of 90 degrees in a direction orthogonal to the thickness direction of the circuit board.

6. The vehicle lamp according to claim 5,
wherein the circuit board is formed in a square shape.

7. The vehicle lamp according to claim 6,
wherein each of the first and second electrodes is formed to have first and second portions that are continuously formed along two continuous side edges of the outer peripheral edges of the circuit board, respectively.

8. The vehicle lamp according to claim 5,
wherein the circuit board has an indicator that indicates orientation of the circuit board to be mounted on the mounting base.
